(19) United States
(12) Patent Application Publication
(10) Pub. No.: US 2024/0352282 A1
(43) Pub. Date: Oct. 24, 2024

(54) DOUBLE-SIDED ADHESIVE TAPE, ARTICLE, AND DISASSEMBLING METHOD

(71) Applicant: 3M INNOVATIVE PROPERTIES COMPANY, St. Paul, MN (US)

(72) Inventor: Yasuhiro Kono, Sagamihara-city, Chuo-ku (JP)

(21) Appl. No.: 18/574,785

(22) PCT Filed: Jun. 29, 2022
(86) PCT No.: PCT/IB2022/056071

§ 371 Date: Dec. 28, 2023

(30) Foreign Application Priority Data
Jun. 29, 2021 (JP) 2021-107512

(51) Int. Cl. C09J 7/20; B32B 7/12; B32B 27/08; B32B 27/16; B32B 27/36; B32B 43/00; C09J 5/00; C09J 7/40

(52) U.S. Cl. CPC C09J 7/201; B32B 7/12; B32B 27/08; B32B 27/16; B32B 27/36; B32B 43/006; C09J 5/00; C09J 7/401; B32B 2250/02; B32B 2250/244; B32B 2255/10; B32B 2255/26; B32B 2307/4026; B32B 2307/54; B32B 2307/542; B32B 2307/558; B32B 2307/748; C09J 2301/124; C09J 2301/502; C09J 2400/24

(57) ABSTRACT

To provide a double-sided adhesive tape with both high adhesive force and excellent ease of disassembly. A double-sided adhesive tape including a first adhesive layer; a separation layer containing a pigment, the separation layer being provided on the first adhesive layer; a film substrate directly laminated on the separation layer; and a second adhesive layer provided on the film substrate, wherein the pigment contains at least one selected from the group consisting of carbon black, titanium oxide, and phthalocyanine blue.

### TECHNICAL FIELD

The present invention relates to a double-sided adhesive tape, an article, and a disassembling method.

### BACKGROUND

A double-sided adhesive material has been used to fix various components to each other, and improvement of an adhesive force and a holding force thereof has been studied.

For example, JP 2010-95722 A discloses a foam tape containing corona-treated foam and an adhesive layer formed on one or both sides.

### SUMMARY

### Technical Problem

As one embodiment of a highly versatile double-sided adhesive tape, there is a demand for a double-sided adhesive tape that can firmly adhere two or more adherends and can be easily disassembled if desired.

However, once a strong adhesive force with the adherend is secured, disassembling tends to be difficult after bonding.

Also, if the peelability of the double-sided adhesive tape is improved and the dissembling property is secured, the adhesive force tends to be insufficient.

Therefore, an object of the present invention is to provide a double-sided adhesive tape with both high adhesive force and excellent ease of disassembly.

Another object of the present invention is to provide an article with both strong adhesion between components and ease of disassembly.

Further, an object of the present invention is to provide a disassembling method capable of easily separating components bonded by the double-sided adhesive tape.

### Solution to Problem

One aspect of the present invention relates to a double-sided adhesive tape including a first adhesive layer; a separation layer containing a pigment, the separation layer being provided on the first adhesive layer; a film substrate directly laminated on the separation layer; and a second adhesive layer provided on the film substrate, wherein the pigment contains at least one selected from the group consisting of carbon black, titanium oxide, and phthalocyanine blue.

According to the double-sided adhesive tape, two or more adherends can be firmly adhered by the first adhesive layer and the second adhesive layer.

Further, as for the above double-sided adhesive tape, by inserting a flat instrument from a side surface of the tape and peeling off an interface between the separation layer and the film substrate, the adherends can be easily separated from each other and disassembled.

In one aspect, the first adhesive layer may be foam.

In one aspect, a tensile stress at break of the separation layer may be less than 4 MPa. The double-sided adhesive tape having such a separation layer has excellent impact resistance after adhesion, and can adhere the adherend more firmly.

In one aspect, the separation layer may be a coating film of a coating liquid containing the pigment and a binder resin, the separation layer containing the pigment and the binder resin.

Such a separation layer tends to have a low tensile stress at break (for example, less than 4 MPa).

In one aspect, the tensile stress at break of the separation layer may be 4 MPa or greater, and the tensile elongation at break of the separation layer may be 360% or less.

A double-sided adhesive tape having such a separation layer can peel off the entire interface more smoothly because re-adhesion after peeling does not easily occur when the interface between the separation layer and the film substrate is peeled off.

In one aspect, the separation layer may be a coating film of a coating liquid containing the pigment, the binder resin, and a curing agent, the separation layer being a layer containing the pigment and a cured product of the binder resin.

Such a separation layer tends to have a high tensile stress at break (for example, 4 MPa or greater) and a low tensile elongation at break (for example, 360% or less).

The double-sided adhesive tape according to one aspect may further include an auxiliary layer directly laminated on the first adhesive layer, wherein the separation layer may be directly laminated on the auxiliary layer.

Another aspect of the present invention relates to an article including a first component; a second component; and a bonding portion that bonds the first component and the second component, the bonding portion including a first region formed of the double-sided adhesive tape having a tensile stress of less than 4 MPa at break of the separation layer, and a second region formed of the double-sided adhesive tape having a tensile stress of 4 MPa or greater at break of the separation layer and a tensile elongation of 360% or less at break of the separation layer.

As for the article, since the first component and the second component have excellent impact resistance after bonding in the first region and are bonded to each other with a double-sided adhesive tape that can bond the adherend more firmly, separation between the first component and the second component due to impact is sufficiently suppressed. Further, in the article, since the first component and the second component are bonded to each other in the second region with a double-sided adhesive tape having more excellent ease of disassembly, by disassembling from the second region as a starting point, the first component and the second component can be easily separated.

Still another aspect of the present invention is a method of disassembling two or more components bonded by the double-sided adhesive tape,
the method including a step of inserting a flat instrument from a side surface of the double-sided adhesive tape and
peeling off an interface between the separation layer and the film substrate.

According to the disassembling method, the components can be easily separated and disassembled.

### Advantageous Effects of Invention

According to the present invention, provided is a double-sided adhesive tape with both high adhesive force and excellent ease of disassembly.

Further, according to the present invention, provided is an article having both strong adhesion between components and ease of disassembly.

Further, according to the present invention, provided is a disassembling method capable of easily separating components bonded by the double-sided adhesive tape.

### BRIEF DESCRIPTION OF THE DRAWINGS

FIG. 1 is a cross-sectional view schematically illustrating an embodiment of a double-sided adhesive tape.

FIG. 2 is a cross-sectional view schematically illustrating another embodiment of a double-sided adhesive tape.

FIG. 3(a) is a cross-sectional view schematically illustrating one embodiment of an article, and FIG. 3(b) is a cross-sectional view illustrating a cross-section taken along line A-A in FIG. 3(a).

FIG. 4 is a diagram for explaining one embodiment of a method of disassembling a double-sided adhesive tape.

### DETAILED DESCRIPTION

Preferred embodiments of the present invention are described below with reference to the drawings. Note that, for the sake of better understanding, a part of the drawings is illustrated with exaggeration, and a ratio of dimensions or the like is not limited to that illustrated in the drawings.

### Double-Sided Adhesive Tape

The double-sided adhesive tape of the present embodiment includes: a first adhesive layer; a separation layer provided on the first adhesive layer, the separation layer containing at least one pigment selected from the group consisting of carbon black, titanium oxide, and phthalocyanine blue; a film substrate directly laminated on the separation layer; and a second adhesive layer provided on the film substrate.

According to the double-sided adhesive tape, two or more adherends can be firmly adhered by the first adhesive layer and the second adhesive layer.

For example, by bonding the components of the first adhesive layer and the second adhesive layer,
an article having two or more components can be easily produced.

Further, in the double-sided adhesive tape of the present embodiment, a flat instrument is inserted from the side surface of the tape to peel off the interface between the separation layer and the film substrate, and thus can the adherends be easily separated and disassembled from each other. That is, in the article provided with the components bonded to each other by the double-sided adhesive tape of the present embodiment, a flat instrument is inserted from the side surface of the double-sided adhesive tape to peel off the interface between the separation layer and the film substrate, and thus can the components be easily separated and disassembled from each other.

The first adhesive layer is a layer mainly formed of an adhesive and may be a layer containing an adhesive.

Examples of the adhesive constituting the first adhesive layer include an acrylic adhesive, a rubber-based adhesive, a urethane-based adhesive,
a silicone-based adhesive, and a block copolymer-based adhesive. The adhesive constituting the first adhesive layer may be an acrylic adhesive.

The first adhesive layer may be a layer containing one type or two or more types of adhesives.

Further, the first adhesive layer may be one layer or two or more layers.

The first adhesive layer may be foam from the viewpoint of facilitating disassembly of the article after adhesion while maintaining sufficient adhesive force.

The fact that the first adhesive layer is foam means that
at least a part of the first adhesive layer is foam. The first adhesive layer may be foam containing an acrylic adhesive, and for example, the technique disclosed in JP 5746828B can be applied.

As the first adhesive layer, for example, commercially available foam tapes can be used. Examples of the commercially available foam tapes include Y-4825, Y-4950, Y-4180, Y-4930, Y-4920, Y-4914, Y-4300, and 86425 (which are all available from 3M).

The thickness of the first adhesive layer (the thickness of the entire first adhesive layer when the first adhesive layer formed of two or more layers) may be, for example, 0.15 mm or greater, 0.2 mm or greater, or 0.4 mm or greater.

When the thickness of the first adhesive layer is 0.15 mm or more, it makes it easy to insert a flat instrument from the side surface of the double-sided adhesive tape, and it makes it even easier to disassemble the components bonded to each other by the double-sided adhesive tape.

The thickness of the first adhesive layer may be, for example, 10 mm or less, 5 mm or less, or 2 mm or less. When the thickness of the first adhesive layer is 10 mm or less, the bonding strength by the first adhesive layer tends to be further improved.

The separation layer is a layer that is provided on the surface of the film substrate and is bonded with the film substrate.

The separation layer is a layer that is peeled off from the surface of the film substrate when the article bonded by the double-sided adhesive tape is disassembled.

The separation layer is a layer containing a pigment, and the pigment contains at least one selected from the group consisting of carbon black, titanium oxide, and phthalocyanine blue.

The double-sided adhesive tape of the present embodiment is provided with a separation layer containing a specific pigment, thereby realizing excellent ease of disassembly without impairing the adhesive force of the first adhesive layer and the second adhesive layer.

The reason for this is considered that the pigment serves as a starting point for peeling when the flat instrument is inserted, so that the separation layer and the film substrate can be easily peeled off.

There is also an aspect that since the separation layer contains the pigment, when the flat instrument is inserted at the side surface of the tape, the coloring of the separation layer serves as a guide for the insertion point, and the workability is improved.

As the carbon black, carbon black as a black pigment can be used without particular limitation.

An average particle size of carbon black may be, for example, 0.008 μm or greater, and be 0.01 μm or greater.

The average particle size of carbon black may be, for example, 0.1 μm or less, and is 0.04 μm or less. The method of measuring the average particle size of carbon black is not particularly limited, and, for example, an arithmetic mean diameter determined by observation on an electron microscope may be within the above-described range.

As the carbon black, for example, commercially available carbon black can be used. Examples of commercially available carbon black include Mitsubishi Carbon Black RCF #85 (available from Mitsubishi Chemical Holdings Corporation).

As titanium oxide, titanium oxide as a white pigment can be used without particular limitation. The average particle size of zinc oxide may be, for example, 0.1 μm or more, and is 0.15 μm or greater.

The average particle size of titanium oxide is, for example, 0.8 μm or less, and 0.35 μm or less. Note that the method of measuring the average particle size of titanium oxide is not particularly limited, and, for example, an arithmetic mean diameter determined by observation on an electron microscope may be within the above-described range.

As the titanium oxide, for example, commercially available titanium oxide can be used. Examples of commercially available titanium oxide include JR-805 (available from TAYCA CORPORATION) and the like.

Examples of phthalocyanine blue include α-type, β-type, and ε-type of copper phthalocyanine, and may be Pigment Blue 15, for example.

As the phthalocyanine blue, for example, commercially available phthalocyanine blue can be used.

Examples of commercially available phthalocyanine blue include cyanine blue 4920 (available from Dainichiseika Color & Chemicals Mfg. Co., Ltd.).

The separation layer may contain a small amount of pigments (other pigments) other than carbon black, titanium oxide, and phthalocyanine blue.

Examples of other pigments include inorganic pigments such as aluminum hydroxide, silica, red iron oxide, antimony red, cadmium red, cadmium yellow, cobalt blue, dark blue, and ultramarine; and organic pigments such as a soluble azo pigment, an insoluble azo pigment, an azolake pigment, a condensed azo pigment, and a condensed polycyclic pigment.

From the viewpoint of obtaining more excellent peeling characteristics, the content of the pigments in the separation layer may be, for example, 1 mass % or greater, 10 mass % or greater, or 20 mass % or greater, based on the total mass of the separation layer.

From the viewpoint of preventing the pigment from adhering to other materials, manufacturing machines, or the like during a producing process, The content of the pigment in the separation layer may be, for example, 85 mass % or less, 80 mass % or less, or 70 mass % or less, based on the total mass of the separation layer.

From the viewpoint of obtaining the above-mentioned effects more remarkably, the content of other pigments in the separation layer may be, for example, less than 50 mass %, preferably 40 mass % or less, more preferably 30 mass % or less, still more preferably 20 mass % or less, 10 mass % or less, 5 mass % or less, or 1 mass % or less, and may be 0 mass %, based on the total mass of the pigment.

The separation layer may further contain a resin component, or may be, for example, a layer in which a pigment is dispersed in the resin component.

The resin component may be a binder resin or a cured product of the binder resin, which are contained in a coating liquid for forming a separation layer.

Examples of the binder resin include a urethane resin (polyurethane resin), a polyurea resin, an acrylic resin (polyacrylate resin), a polyester resin, a polyamide resin, and a cured product thereof.

Inks on the market often contain a urethane resin.

The separation layer containing the cured product of the binder resin can be formed by using a coating liquid containing the binder resin and the curing agent.

The curing agent may be appropriately selected depending on the type of binder resin. For example, when the binder resin contains a urethane resin, Coronate L or the like can be used as the curing agent.

From the viewpoint of further improving the adhesive force with the film substrate, the binder resin may have a glass transition temperature of, for example, 0° C. or lower, −10° C. or lower, −20° C. or lower, or −30° C. or lower.

The glass transition temperature of the binder resin may be, for example, −70° C. or higher or may be −60° C. or higher.

The separation layer can be formed by using a commercially available ink containing a pigment or a coating liquid in which a curing agent is added to the ink.

Examples of commercially available inks containing carbon black include R ink 1000 of Lamiall Mark III series (available from SAKATA INX CORPORATION) and F220 795 ink of Lamic series (available from Dainichiseika Color & Chemicals Mfg. Co., Ltd.).

Examples of commercially available inks containing titanium oxide include R White 110 of Lamiall Mark III series (available from SAKATA INX CORPORATION), F220 701 White of Lamic series (available from Dainichiseika Color & Chemicals Mfg.Co.,Ltd.), R61S White of Lamistar series (available from TOYO INK SC HOLDINGS CO., LTD.). Examples of commercially available inks containing phthalocyanine blue include R indigo 800 of Lamill Mark III series (available from SAKATA INX CORPORATION) and F220 739 indigo of Lamic series (available from Dainichiseika Color & Chemicals Mfg. Co., Ltd.).

The thickness of the separation layer may be, for example, 0.01 μm or greater, 0.1 μm or greater, or 0.5 μm or greater. The thickness of the separation layer may be, for example, 5 μm or less, 3 μm or less, or 2 μm or less.

In a preferred embodiment, a tensile stress at break of the separation layer may be less than 4 MPa at break (hereinafter, also referred to as a separation layer (A)).

The double-sided adhesive tape having such a separation layer has excellent impact resistance after adhesion, and can adhere the adherend more firmly.

The separation layer may be, for example, a coating film of a coating liquid (hereinafter, also referred to as a coating liquid (a)) containing a pigment and a binder resin, and may be a layer containing a pigment and a binder resin.

Since such a separation layer has a low tensile stress at break (for example, less than 4 MPa), it can be suitably used as the above-mentioned separation layer (A).

The content of the pigment in the coating liquid (a) may be, for example, 1 mass % or greater, 10 mass % or greater, or 20 mass % or greater based on the total amount of solid content.

The content of the pigment in the coating liquid (a) may be, for example, 85 mass % or less, 80 mass % or less, or 70 mass % or less based on the total amount of solid content.

The content of the binder resin in the coating liquid (a) may be, for example, 15 mass % or greater, 20 mass % or greater, or 25 mass % or greater based on the total amount of solid content. The content of the binder resin in the coating liquid (a) may be, for example, 99 mass % or less, 90 mass % or less, 80 mass % or less, 70 mass % or less, and 60 mass % or less based on the total amount of solid content.

The solvent of the coating liquid (a) is not particularly limited, and examples thereof include known organic solvents such as aromatic organic solvents such as toluene and xylene, ketone-based organic solvents such as methyl ethyl ketone and methyl isobutyl ketone, ester-based organic solvents such as ethyl acetate, n-propyl acetate, isopropyl acetate, and isobutyl acetate, alcohol-based organic solvents such as methanol, ethanol, n-propanol, isopropanol, and n-butanol, and glycol ether solvents such as ethylene glycol monopropyl ether and propylene glycol monomethyl ether, and these may be mixed and used.

In another preferred embodiment, the separation layer may be a layer demonstrating a tensile stress at break of 4 MPa or more and a tensile elongation of 360% or less (hereinafter, also referred to as a separation layer (B)).

The double-sided adhesive tape having such a separation layer can peel off the entire interface more smoothly because re-adhesion after peeling does not easily occur when the interface between the separation layer and the film substrate is peeled off.

The separation layer may be, for example, a coating film of a coating liquid (hereinafter, also referred to as a coating liquid (b)) containing a pigment, a binder resin, and a curing agent, and may be a layer containing a pigment and a cured product of a binder resin.

Since such a separation layer tends to demonstrate a high tensile stress at break (for example, 4 MPa or greater) and a low tensile elongation at break (for example, 360% or less), it can be suitably used as the above-mentioned separation layer (B).

The content of the pigment in the coating liquid (b) may be, for example, 1 mass % or greater, 10 mass % or greater, or 20 mass % or greater based on the total amount of solid content. The content of the pigment in the coating liquid (a) may be, for example, 85 mass % or less, 80 mass % or less, or 70 mass % or less based on the total amount of solid content.

The content of the binder resin in the coating liquid (b) may be, for example, 15 mass % or greater, 20 mass % or greater, and 25 mass % or less, based on the total amount of solid content.

The content of the binder resin in the coating liquid (b) may be, for example, 99 mass % or less, 90 mass % or less, 80 mass % or less, 70 mass % or less, and 60 mass % or less based on the total amount of solid content.

The content of the curing agent in the coating liquid (b) may be appropriately adjusted according to the type of the binder resin, for example, it may be appropriately adjusted so as to satisfy the above-mentioned numerical values of the tensile stress at break and the tensile elongation at break.

The content of the curing agent in the coating liquid (b) is, for example, 0.01 parts by mass or greater, 0.03 parts by mass or greater, and 0.05 parts by mass or greater, based on the total amount of the solid content.

The content of the curing agent in the coating liquid (b) is, for example, 15 parts by mass or less and 10 parts by mass or less, based on the total amount of the solid content.

The solvent of the coating liquid (b) is not particularly limited, and examples thereof include known organic solvents such as aromatic organic solvents such as toluene and xylene, ketone-based organic solvents such as methyl ethyl ketone and methyl isobutyl ketone, ester-based organic solvents such as ethyl acetate, n-propyl acetate, isopropyl acetate, and isobutyl acetate, alcohol-based organic solvents such as methanol, ethanol, n-propanol, isopropanol, and n-butanol, and glycol ether solvents such as ethylene glycol monopropyl ether and propylene glycol monomethyl ether, and these may be mixed and used.

In the double-sided adhesive tape of the present embodiment, the layer located between the first adhesive layer and the film substrate may be collectively referred to as an intermediate layer. The intermediate layer may have a single-layer structure having only a separation layer, or may have a multilayer structure having a separation layer and a layer other than the separation layer (for example, an auxiliary layer described later).

The double-sided adhesive tape of the present embodiment may further include an auxiliary layer on the surface of the separation layer opposite to the film substrate (that is, the surface on the side of the first adhesive layer). The auxiliary layer may be a layer for enhancing the adhesiveness between the first adhesive layer and the separation layer.

The auxiliary layer may be a layer directly laminated on the first adhesive layer. Further, the separation layer may be directly laminated on the auxiliary layer.

The auxiliary layer may be, for example, a layer containing a resin component. As the resin component in the auxiliary layer, the same one as exemplified as the resin component in the separation layer can be exemplified.

The resin component in the auxiliary layer is not particularly limited, and from the viewpoint of the excellent tensile shear force, a cured product of the binder resin is preferable.

The auxiliary layer may be, for example, a layer containing a pigment, or may be a layer containing a resin component and a pigment.

As the pigment in the auxiliary layer, the same ones as those exemplified as the pigment in the separation layer can be exemplified.

When disassembling the double-sided adhesive tape, it is necessary to insert a flat instrument from the side surface of the tape so that the interface between the separation layer and the film substrate is peeled off, however, when the double-sided adhesive tape is provided with an auxiliary layer containing a pigment in the vicinity of the separation layer, the auxiliary layer serves as a guide for the insertion point of the instrument, and disassembly becomes easier.

The pigment in the auxiliary layer is not particularly limited, and may be at least one selected from the group consisting of carbon black, titanium oxide, and phthalocyanine blue, and may be other pigments described above.

The thickness of the auxiliary layer may be, for example, 0.01 μm or greater, 0.1 μm or greater, or 0.5 μm or greater. The thickness of the auxiliary layer may be, for example, 5 μm or less, 3 μm or less, or 2 μm or less.

The entire thickness of the intermediate layer may be, for example, 0.02 μm or more, 0.2 μm or greater, or 1.0 μm or greater. The entire thickness of the intermediate layer may be 10 μm or less, 6 μm or less, or 4 μm or less.

The film substrate is a layer provided between the separation layer and the second adhesive layer, and is directly laminated on the separation layer.

The film substrate is in contact with the separation layer, and this interface is peeled off at the time of dissembling, which will be described later.

The film substrate may be in contact with the second adhesive layer. The surface of the film substrate to be bonded to the second adhesive layer may be corona-treated.

The material of the film substrate is not particularly limited, and may be a resin such as polyethylene terephthalate (PET), polyethylene naphthalate (PEN), polyethylene (PE), polypropylene (PP), acrylic, polyimide (PI), polyphenylene sulfide (PPS), and polycarbonate (PC).

The thickness of the film substrate may be, for example, 10 μm or greater, 12 μm or greater, 25 μm or greater, or 38 μm or greater. The thickness of the film substrate may be, for example, 100 μm or less, 75 μm or less, or 50 μm or less.

The second adhesive layer is a layer mainly formed of an adhesive and may be a layer containing an adhesive.

Examples of the adhesive constituting the second adhesive layer include an acrylic adhesive, a rubber-based adhesive, a urethane-based adhesive, a silicone-based adhesive, and a block copolymer-based adhesive, and preferably an acrylic adhesive.

The second adhesive layer may have the same configuration as the first adhesive layer, or may have a different configuration. The second adhesive layer may be a layer containing one type or two or more types of adhesives, or may be a layer containing two or more types of adhesives. The second adhesive layer may be foam.

The second adhesive layer may be one or more layers.

The thickness of the second adhesive layer (the thickness of the entire second adhesive layer when the second adhesive layer formed of a plurality of layers) is not particularly limited, and may be, for example, 10 μm or greater or 20 μm or greater.

The thickness of the second adhesive layer may be, for example, 100 μm or less, 80 μm or less, or 60 μm or less.

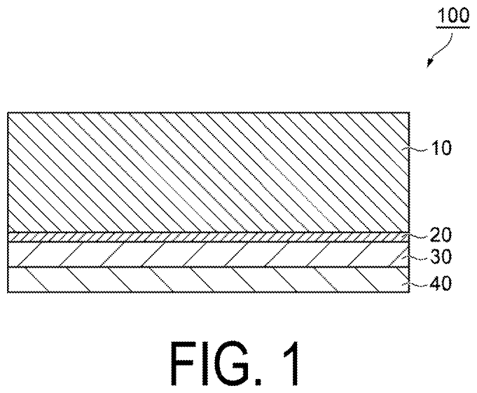

FIG. 1 is a cross-sectional view schematically illustrating an embodiment of a double-sided adhesive tape. A double-sided adhesive tape 100 includes a first adhesive layer 10, a separation layer 20, a film substrate 30, and a second adhesive layer 40.

In the double-sided adhesive tape 100, the separation layer 20 is directly laminated on the first adhesive layer 10, the film substrate 30 is directly laminated on the separation layer 20, and the second adhesive layer 40 is directly laminated on the film substrate 30.

In the double-sided adhesive tape 100, another layer may be interposed between the first adhesive layer 10 and the separation layer 20.

Further, another layer may be interposed between the film substrate 30 and the second adhesive layer 40.

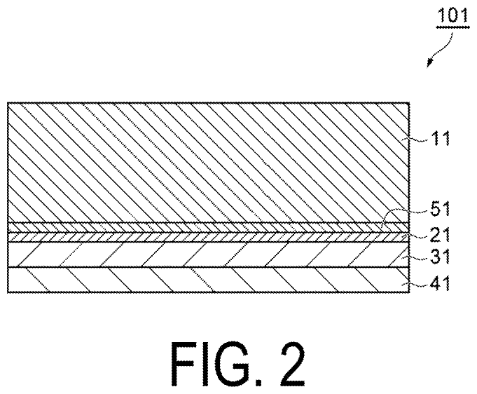

FIG. 2 is a cross-sectional view schematically illustrating another embodiment of a double-sided adhesive tape. A double-sided adhesive tape 101 in FIG. 2 includes a first adhesive layer 11, an intermediate layer including an auxiliary layer 51 and a separation layer 21, a film substrate 31, and a second adhesive layer 41.

In the double-sided adhesive tape 101, the auxiliary layer 51 is directly laminated on the first adhesive layer 11, the separation layer 21 is directly laminated on the auxiliary layer 51, the film substrate 31 is directly laminated on the separation layer 21, and the second adhesive layer 41 is directly laminated on the film substrate 31.

In the double-sided adhesive tape 101, another layer may be interposed between the first adhesive layer 11 and the auxiliary layer 51.

In addition, another layer may be interposed between the auxiliary layer 51 and the separation layer 21.

Further, another layer may be interposed between the film substrate 31 and the second adhesive layer 41.

### Article

The article of the present embodiment includes a first component, a second component, and a bonding portion that bonds the first component and the second component to each other.

The bonding portion includes a first region formed of a first double-sided adhesive tape including the separation layer (A), and a second region formed of a second double-sided adhesive tape including the separation layer (B).

By using the first double-sided adhesive tape and the second double-sided adhesive tape in combination, both excellent impact resistance and excellent ease of disassembly can be achieved.

As for the article, since the first component and the second component have excellent impact resistance after bonding in the first region and are bonded to each other with a first double-sided adhesive tape that can bond the adherend more firmly, separation between the first component and the second component due to impact is sufficiently suppressed.

Further, in the article of the present embodiment, since the first component and the second component are bonded in the second region by a second double-sided adhesive tape having excellent ease of disassembly, by disassembling from the second region as a starting point, the first component and the second component can be easily separated.

When the bonding portion has a corner portion (edge), the corner portion is preferably a first region.

With this, the corner portions that easily peel off are firmly adhered by the first double-sided adhesive tape, and the impact resistance after bonding is further improved.

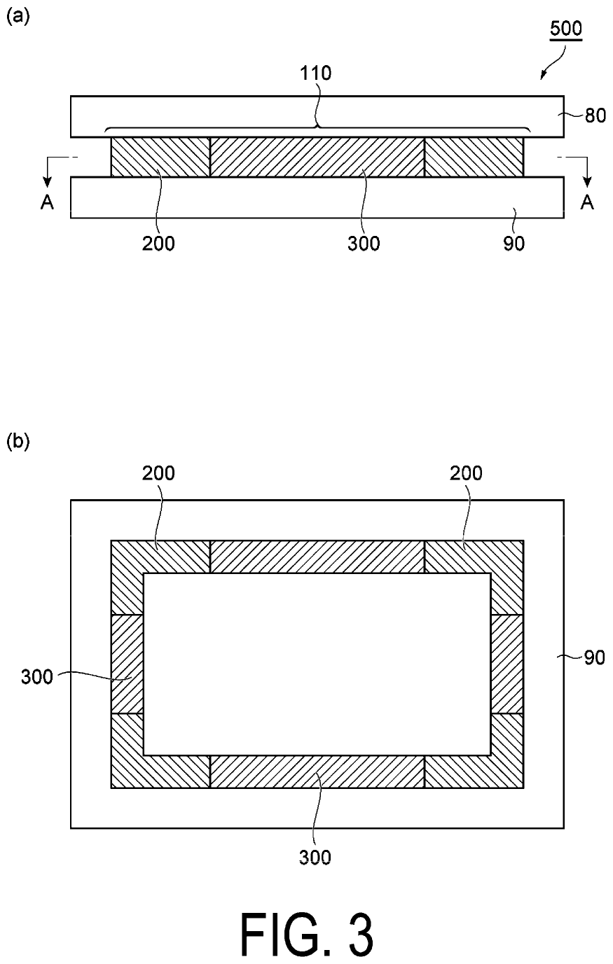

FIG. 3(a) is a cross-sectional view schematically illustrating one embodiment of an article, and FIG. 3(b) is a cross-sectional view illustrating a cross-section taken along line A-A in FIG. 3(a).

An article 500 illustrated in FIG. 3(a) includes a first component 80, a second component 90, and a bonding portion 110 that bonds the first component 80 and the second component 90 to each other.

The bonding portion 110 includes a first region 200 formed of a first double-sided adhesive tape and a second region 300 formed of a second double-sided adhesive tape.

As illustrated in FIG. 3(b), the bonding portion 110 of the article 500 is formed in a rectangular frame shape, a first region 200 is formed at a corner portion, and a second region 300 is formed between the corner portions (side portions).

The article 500 has excellent impact resistance because the four corners are firmly adhered in the first region 200.

Further, in the article 500, the first component 80 and the second component 90 can be easily separated and disassembled by inserting an instrument having a flat portion into the second region 300.

In the article 500, the bonding portion 110 has a rectangular frame shape, but the shape of the bonding portion in the article of the present embodiment is not limited to this.

In the article 500, the first region 200 and the second region 300 are arranged adjacent to each other.

However, in the article of the present embodiment, the first region and the second region may be arranged apart from each other, and may be arranged so that a part thereof overlaps with each other.

The article of the present embodiment may be, for example, a monitor such as a personal computer, an electronic board, a sensor, or the like.

That is, the double-sided adhesive tape of the present embodiment may be used for fixing the components constituting these articles.

### Method of Producing Double-Sided Adhesive Tape

The double-sided adhesive tape of the present embodiment may be produced by a producing method including, for example, a separation layer forming step of directly applying a coating liquid containing a pigment on one surface of a film substrate to form a separation layer containing a pigment, and a first adhesive layer forming step of laminating the first adhesive layer on the separation layer.

In the above producing method, the separation layer forming step may be a step of directly applying the coating liquid for forming a separation layer on one surface of the film substrate to form the separation layer.

The second adhesive layer may be formed on the film substrate before the separation layer forming step, or may be formed on the film substrate after the separation layer forming step.

Further, the first adhesive layer forming step may be performed before or after a step of forming a second adhesive layer.

The second adhesive layer can be formed, for example, by directly applying an adhesive solution for forming a second adhesive layer onto the surface of the substrate.

A coating device for applying the adhesive solution for forming a second adhesive layer onto the surface of the substrate may be, for example, a coater such as a bar coater, a knife coater, a roll coater, or a die coater.

When one side of the film substrate is surface-treated (for example, corona-treated), the film substrate and the second adhesive layer are preferably bonded to each other so that the corona-treated surface of the film substrate is on the side of the second adhesive layer.

For the separation layer can be formed by, for example, applying a coating liquid for forming a separation layer on one surface of the film substrate (for example, on the surface not bonded to the second adhesive layer), and drying and solidifying.

The method of applying the coating liquid is not particularly limited, and the coating liquid may be applied by a coater such as a gravure coater, or may be applied by spraying or the like.

The coating liquid may be the above-mentioned ink or a mixture of the ink and the curing agent, or may be one obtained by mixing ink with a diluting solvent and adjusting the viscosity.

The above-mentioned production method may further include an auxiliary layer forming step of forming an auxiliary layer on the separation layer before the first adhesive layer forming step.

In this case, the first adhesive layer forming step may be a step of laminating the first adhesive layer on the auxiliary layer.

The auxiliary layer can be formed, for example, by applying a coating liquid for forming an auxiliary layer on the separation layer, drying and solidifying the auxiliary layer.

The method of applying the coating liquid is not particularly limited, and the coating liquid may be applied by a coater such as a gravure coater, or may be applied by spraying or the like.

The coating liquid may be the above-mentioned ink or a mixture of the ink and the curing agent, or may be one obtained by mixing ink with a diluting solvent and adjusting the viscosity.

The first adhesive layer can be formed, for example, by laminating the adhesive layer formed on the peeling surface of the liner on the separation layer or the auxiliary layer.

Further, the first adhesive layer may be formed by laminating a commercially available foam tape on the separation layer or the auxiliary layer.

### Method of Disassembling Double-Sided Adhesive Tape

The double-sided adhesive tape of the present embodiment can be disassembled by, for example, the following method after bonding the components.

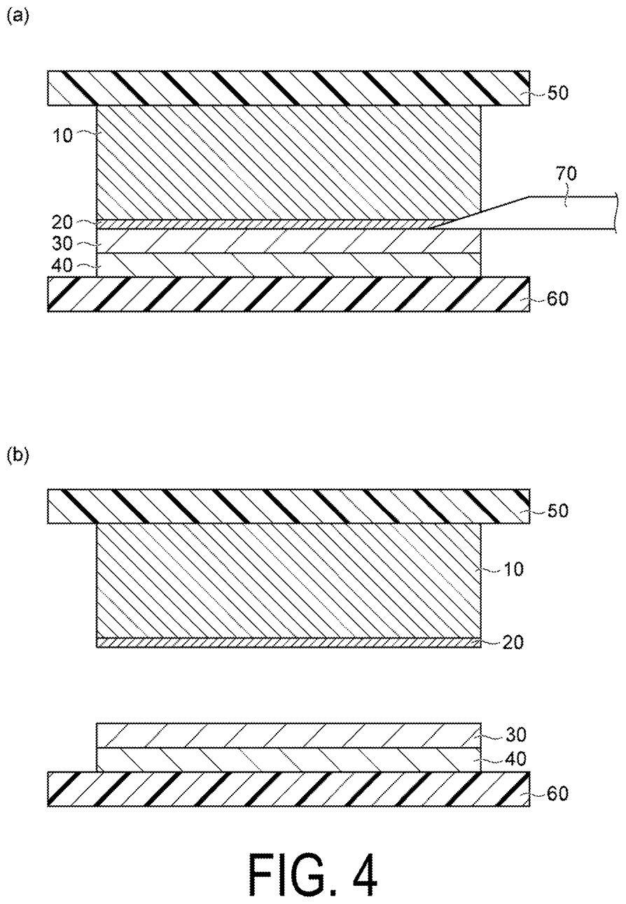

FIG. 4 is a diagram for explaining one embodiment of a method of disassembling a double-sided adhesive tape. A method of separating a first component 50 and a second component 60 bonded to each other by the double-sided adhesive tape 100 (it can also be said to be a method of disassembling an article including the first component 50 and the second component 60) includes a step of inserting a flat instrument 70 from a side surface of the double-sided adhesive tape 100 that bonds the first component 50 and the second component 60 to each other, and then peeling off an interface between a separation layer 20 and a film substrate 30.

The flat instrument 70 may be an instrument having a flat portion, and examples thereof include a scraper and a knife.

The material of the flat portion is not particularly limited, and may be made of metal, resin, or the like.

The article to be dissembled is not limited to the one formed of two components, and may be formed of three or more components.

Each component may be made of the same material, or any or all of them may be made of different materials.

After inserting the flat portion of the flat instrument 70 into the side surface of the double-sided adhesive tape 100 so as to be substantially parallel to the interface between the separation layer 20 and the film substrate 30, for example, by moving the flat portion of the flat instrument 70 along the interface between the separation layer 20 and the film substrate 30, the separation layer 20 and the film substrate 30 can be efficiently peeled off.

Further, by rotating the inserted flat portion, the peeling surface between the separation layer 20 and the film substrate 30 can be widened and peeled.

Although descriptions were given above for the preferred embodiments of the present invention, the present invention is not limited to the aforementioned embodiments.

### EXAMPLES

Hereinafter, the contents of the present invention will be described in more detail with reference to Examples and Comparative Examples, but the present invention is not intended to be limited to the Examples described below.

### Example 1-1

After obtaining 100 parts by mass of an ink mixture by mixing 80 parts by mass of ink (Lamiall Mark III R61S White, available from SAKATA INX CORPORATION) containing a pigment (titanium oxide) and a urethane resin and 20 parts by mass of ink (Lamiall Mark III R Black Ink 1000, available from SAKATA INX CORPORATION) containing a pigment (carbon black) and a urethane resin, a diluting solvent (a mixture of 60 parts by mass of methyl ethyl ketone, 30 parts by mass of toluene, and 10 parts by mass of isopropyl alcohol) was added and stirred so as to keep a viscosity that allows steady flow of a mixed liquid from the orifice was stopped in 20 seconds according to the viscosity measurement by Zahn Cup No. 3, and a coating liquid for forming a separation layer was adjusted.

After obtaining a mixture by mixing 100 parts by mass of ink (Lamic F220 701 White, available from Dainichiseika Color & Chemicals Mfg.Co.,Ltd.) containing a pigment (titanium oxide) and a urethane resin and 3 parts by mass of curing agent (Coronate L-45, available from TOSOH CORPORATION), a diluting solvent (a mixture of 60 parts by mass of methyl ethyl ketone, 30 parts by mass of toluene, and 10 parts by mass of isopropyl alcohol) was added and stirred so as to keep a viscosity that allows a steady flow of a mixed liquid from the orifice was stopped in 20 seconds according to the viscosity measurement by Zahn Cup No. 3, and a coating liquid for forming an auxiliary layer was adjusted.

The coating liquid for forming a separation layer and the coating liquid for forming an auxiliary layer adjusted above were set to a gravure printing machine (multi-color printing machine, dryer inside length of 2 m after each gravure coating) equipped with each gravure roll (pyramid type, 150 lines, plate depth 40 μm) for the separation layer and the auxiliary layer so that a coating order was the separation layer, then the auxiliary layer.

By using a PET film (EMBLET S-50, available from UNITIKA LTD.) having a thickness of 50 μm in which only one side was corona-treated was used as a film substrate, a coating liquid for forming a separation layer was applied to the untreated corona surface of the film substrate at a line speed of 50 m/min, dried with a dryer at a temperature of 80° C., and then a coating liquid for forming an auxiliary layer was continuously applied on the separation layer at a line speed of 50 m/min and dried with a dryer having a temperature of 80° C. to form an intermediate layer (separation layer and auxiliary layer) having a thickness from 0.8 to 1.5 μm.

After that, the coated roll was cured at 40° C. for 24 hours.

To 100 parts by mass of an adhesive (SK-Dyne1503, available from Soken Chemical Co., Ltd.), 3 parts by mass of a curing agent (Coronate L-45 available from TOSOH CORPORATION) was added and stirred, and an adhesive composition was obtained.

The obtained adhesive composition was applied to the corona-treated surface (the surface opposite to the separation layer) of the film substrate with a knife coater, and dried in a drying device at 65° C. for 3 minutes.

As a result, a laminate in which a second adhesive layer having a thickness of 40 μm, a film substrate, a separation layer, and an auxiliary layer were laminated in this order was obtained.

Next, in order to protect the second adhesive layer, a silicone-treated PET film (Purex A50 available from TOYOBO FILM SOLUTIONS LIMITED) was laminated on the second adhesive layer.

A first adhesive layer was formed by covering the auxiliary layer of the obtained laminate with an adhesive layer of a foam tape (Y-4825K-08, available from 3M) having a thickness of 0.8 mm so as to prevent bubbles from entering to prepare a double-sided adhesive tape by squeezing with a squeegee.

### Example 2-1

A double-sided adhesive tape was prepared in the same manner as in Example 1-1 except that as the ink for preparing the coating liquid for forming a separation layer, 100 parts by mass of ink (Lamiall Mark III R Indigo 800, available from SAKATA INX CORPORATION) containing the pigment (phthalocyanine blue) and the urethane resin was used and the amount of the curing agent in the coating liquid for forming an auxiliary layer was set to 1 part by mass.

### Example 2-2

A double-sided adhesive tape was prepared in the same manner as in Example 2-1 except that the first adhesive layer was formed using a foam tape having a thickness of 0.2 mm (Y-4914, available from 3M).

### Example 2-3

A double-sided adhesive tape was prepared in the same manner as in Example 2-1 except that the first adhesive layer was formed using a foam tape having a thickness of 0.25 mm (86425, available from 3M).

### Example 3-1

A double-sided adhesive tape was prepared in the same manner as in Example 1-1 except that as the ink for preparing the coating liquid for forming a separation layer, 100 parts by mass of ink (Lamiall Mark III R Indigo 800, available from SAKATA INX CORPORATION) containing the pigment (phthalocyanine blue) and the urethane resin was used and the amount of the curing agent in the coating liquid for forming an auxiliary layer was set to 2 parts by mass.

### Example 3-2

A double-sided adhesive tape was prepared in the same manner as in Example 3-1 except that the first adhesive layer was formed using a foam tape having a thickness of 0.2 mm (Y-4914, available from 3M).

### Example 3-3

A double-sided adhesive tape was prepared in the same manner as in Example 3-1 except that the first adhesive layer was formed using a foam tape having a thickness of 0.25 mm (86425, available from 3M).

### Example 4-1

A double-sided adhesive tape was prepared in the same manner as in Example 1-1 except that as the ink for preparing the coating liquid for forming a separation layer, a mixture of 100 parts by mass of ink (Lamiall Mark III R Indigo 800, available from SAKATA INX CORPORATION) containing the pigment (phthalocyanine blue) and the urethane resin and the ink (Lamiall Mark III R Black Ink 1000, available from SAKATA INX CORPORATION) the pigment (carbon black) and the urethane resin (mixing ratio of the ink 75:25 (mass ratio)) was used.

### Example 4-2

A double-sided adhesive tape was prepared in the same manner as in Example 4-1 except that the first adhesive layer was formed using a foam tape having a thickness of 0.25 mm (86425, available from 3M).

### Example 5-1

A double-sided adhesive tape was prepared in the same manner as in Example 1-1 except that as the ink for preparing the coating liquid for forming a separation layer, 100 parts by mass of an ink mixture prepared by mixing ink (R Indigo 800 of Lamiall Mark III available from SAKATA INX CORPORATION) containing the pigment (phthalocyanine blue) and the urethane resin and ink (Lamiall Mark III R Black Ink 1000, available from SAKATA INX CORPORATION) containing the pigment (carbon black) and the urethan resin at 75:25 (mass ratio) was used, and as the ink for preparing the coating liquid for forming an auxiliary layer, ink (Lamiall Mark III R Black Ink 1000, available from SAKATA INX CORPORATION) containing the pigment (carbon black) and the urethan resin was used.

### Example 5-2

A double-sided adhesive tape was prepared in the same manner as in Example 5-1 except that the first adhesive layer was formed using a foam tape having a thickness of 0.2 mm (Y-4914, available from 3M).

### Example 6-1

A double-sided adhesive tape was prepared in the same manner as in Example 1-1 except that as the ink for preparing the coating liquid for forming a separation layer, 100 parts by mass of ink (Lamic F220 795 Black Ink, available from Dainichiseika Color & Chemicals Mfg. Co., Ltd.) containing the pigment (carbon black) and the urethane resin was used, and the auxiliary layer was not formed.

### Example 7-1

A double-sided adhesive tape was prepared in the same manner as in Example 1-1 except that as the coating liquid for forming a separation layer, a mixture obtained by adding and stirring 100 parts by mass of ink (Lamic F220 739 Indigo, available from Dainichiseika Color & Chemicals Mfg. Co., Ltd.) containing the pigment (phthalocyanine blue) and the urethane resin, 1 part by mass of curing agent (Coronate L-45, available from Tosoh Corporation), and 100 parts by mass of diluted solvent (mixing ratio of methyl ethyl ketone:toluene=2:1 (mass ratio)) was used, and the curing agent in the coating liquid for forming an auxiliary layer was set to 1 part by mass.

### Example 8-1

A double-sided adhesive tape was prepared in the same manner as in Example 7-1 except that the amount of the curing agent in the coating liquid for an auxiliary layer was set to 2 parts by mass.

### Example 9-1

A double-sided adhesive tape was prepared in the same manner as in Example 7-1 except that the amount of the curing agent in the coating liquid for a separation layer was set to 5 parts by mass.

### Example 9-2

A double-sided adhesive tape was prepared in the same manner as in Example 9-1 except that the first adhesive layer was formed using a foam tape having a thickness of 0.2 mm (Y-4914, available from 3M).

### Example 9-3

A double-sided adhesive tape was prepared in the same manner as in Example 9-1 except that the first adhesive layer was formed using a foam tape having a thickness of 0.25 mm (86425, available from 3M).

### Example 10-1

A double-sided adhesive tape was prepared in the same manner as in Example 7-1 except that the amount of the curing agent in the coating liquid for a separation layer was set to 5 parts by mass, and the amount of the curing agent in the coating liquid for forming an auxiliary layer was set to 2 parts by mass.

### Example 10-2

A double-sided adhesive tape was prepared in the same manner as in Example 10-1 except that the first adhesive layer was formed using a foam tape having a thickness of 0.2 mm (Y-4914, available from 3M).

### Example 10-3

A double-sided adhesive tape was prepared in the same manner as in Example 10-1 except that the first adhesive layer was formed using a foam tape having a thickness of 0.25 mm (86425, available from 3M).

### Example 11-1

A double-sided adhesive tape was prepared in the same manner as in Example 7-1 except that the amount of the curing agent in the coating liquid for a separation layer was set to 3 parts by mass, and the amount of the curing agent in the coating liquid for forming an auxiliary layer was set to 3 parts by mass.

### Example 11-2

A double-sided adhesive tape was prepared in the same manner as in Example 11-1 except that the first adhesive layer was formed using a foam tape having a thickness of 0.2 mm (Y-4914, available from 3M).

### Example 11-3

A double-sided adhesive tape was prepared in the same manner as in Example 11-1 except that the first adhesive layer was formed using a foam tape having a thickness of 0.25 mm (86425, available from 3M).

### Example 12-1

A double-sided adhesive tape was prepared in the same manner as in Example 7-1 except that the amount of the curing agent in the coating liquid for a separation layer was set to 5 parts by mass, and the amount of the curing agent in the coating liquid for forming an auxiliary layer was set to 3 parts by mass.

### Example 13-1

A double-sided adhesive tape was prepared in the same manner as in Example 7-1 except that the amount of the curing agent in the coating liquid for a separation layer was set to 5 parts by mass, ink (Lamiall Mark III R Indigo 800, available from SAKATA INX CORPORATION) containing the pigment (phthalocyanine blue) and urethane resin was used as the ink for preparing the coating liquid for forming an auxiliary layer, and the amount of the curing agent in the coating liquid for forming an auxiliary layer was set to 3 parts by mass.

### Example 13-2

A double-sided adhesive tape was prepared in the same manner as in Example 13-1 except that the first adhesive layer was formed using a foam tape having a thickness of 0.2 mm (Y-4914, available from 3M).

### Example 13-3

A double-sided adhesive tape was prepared in the same manner as in Example 13-1 except that the first adhesive layer was formed using a foam tape having a thickness of 0.25 mm (86425, available from 3M).

### Example 14-1

A double-sided adhesive tape was prepared in the same manner as in Example 7-1 except that the amount of the curing agent in the coating liquid for a separation layer was set to 5 parts by mass, ink (Lamiall Mark III R Black Ink 1000, available from SAKATA INX CORPORATION) containing the pigment (carbon black) and urethane resin was used as the ink for preparing the coating liquid for forming an auxiliary layer, and the amount of the curing agent in the coating liquid for forming an auxiliary layer was set to 3 parts by mass.

### Example 14-2

A double-sided adhesive tape was prepared in the same manner as in Example 14-1 except that the first adhesive layer was formed using a foam tape having a thickness of 0.2 mm (Y-4914, available from 3M).

### Example 14-3

A double-sided adhesive tape was prepared in the same manner as in Example 14-1 except that the first adhesive layer was formed using a foam tape having a thickness of 0.25 mm (86425, available from 3M).

### Example 15-1

A double-sided adhesive tape was prepared in the same manner as in Example 7-1 except that as the ink for preparing the coating liquid for forming a separation layer, 100 parts by mass of ink (Lamistar R61S White, available from TOYO INK SC HOLDINGS CO., LTD.) containing the pigment (titanium oxide) and the urethane resin was used, the amount of the curing agent in the coating liquid for forming an auxiliary layer was set to 5 parts by mass, ink (Lamiall Mark III R Black Ink 1000, available from SAKATA INX CORPORATION) containing the pigment (carbon black) and urethane resin was used as the ink for preparing the coating liquid for forming an auxiliary layer was used, and the amount of the curing agent in the coating liquid for forming an auxiliary layer was set to 3 parts by mass.

### Example 16-1

A double-sided adhesive tape was prepared in the same manner as in Example 7-1 except that, as the ink for preparing the coating liquid for forming a separation layer, 100 parts by mass of ink (Lamistar R61S White, available from TOYO INK SC HOLDINGS CO., LTD.) containing the pigment (titanium oxide) and the urethane resin was used, the amount of the curing agent in the coating liquid for forming an auxiliary layer was set to 5 parts by mass, and as the ink for preparing the coating liquid for forming an auxiliary layer, ink (Lamic F220 701 White, available from Dainichiseika Color & Chemicals Mfg.Co.,Ltd.) containing the pigment (titanium oxide) and the urethane resin was used, and the amount of the curing agent in the coating liquid for forming an auxiliary layer was set to 3 parts by mass.

### Example 17-1

A double-sided adhesive tape was prepared in the same manner as in Example 7-1 except that as the ink for preparing the coating liquid for forming a separation layer, 100 parts by mass of ink (Lamic F220 795 Black Ink, available from Dainichiseika Color & Chemicals Mfg. Co., Ltd.) containing the pigment (carbon black) and the urethane resin was used, the amount of the curing agent in the coating liquid for forming a separation layer was set to 5 part by mass, and the auxiliary layer was not formed.

### Example 17-2

A double-sided adhesive tape was prepared in the same manner as in Example 18-1 except that the first adhesive layer was formed using a foam tape having a thickness of 0.23 mm (86425, available from 3M).

### Comparative Example 1

A double-sided adhesive tape was prepared in the same manner as in Example 1-1 except that as the ink for preparing the coating liquid for forming a separation layer, 100 parts by mass of ink (Lamic F 220 779 Grass, available from Dainichiseika Color & Chemicals Mfg. Co., Ltd) containing a pigment (mainly chloro copper phthalocyanine) and a urethane resin was used, and an auxiliary layer was not formed.

### Comparative Example 2

A double-sided adhesive tape was prepared in the same manner as in Comparative Example 1 except that as the coating liquid for forming a separation layer, 5 parts by mass of curing agent (Coronate L-45, available from TOSOH CORPORATION) was contained.

### Comparative Example 3

A double-sided adhesive tape was prepared in the same manner as in Comparative Example 1 except that as the ink for preparing the coating liquid for forming a separation layer, 100 parts by mass of ink (Lamic F220 950 Red, available from Dainichiseika Color & Chemicals Mfg.Co.,Ltd.) containing a pigment (monoazo-based pigment) and a urethane resin was used.

### Comparative Example 4

A double-sided adhesive tape was prepared in the same manner as in Comparative Example 1 except that as the ink for preparing the coating liquid for forming a separation layer, 100 parts by mass of ink (Lamic F220 950 Red, available from Dainichiseika Color & Chemicals Mfg. Co., Ltd.), 5 parts by mass of curing agent Coronate L-45, available from TOSOH CORPORATION) containing a pigment (monoazo-based pigment) and a urethane resin was used.

### Comparative Example 5

A double-sided adhesive tape was prepared in the same manner as in Comparative Example 1 except that as the ink for preparing the coating liquid for forming a separation layer, 100 parts by mass of ink (Lamiall Mark III R Bright Red 365, available from SAKATA INX CORPORATION) containing a pigment (disazo-based pigment) and a urethane resin was used.

### Comparative Example 6

A double-sided adhesive tape was prepared in the same manner as in Comparative Example 1 except that as the ink for preparing the coating liquid for forming a separation layer, 100 parts by mass of ink (Lamiall Mark III R Bright Red 365, available from SAKATA INX CORPORATION) containing a pigment (disazo-based pigment) and a urethane resin was used, and 5 parts by mass of curing agent (Coronate L-45, available from TOSOH CORPORATION) was contained in the coating liquid for forming an auxiliary layer.

### Comparative Example 7

A double-sided adhesive tape was prepared in the same manner as in Example 1-1 except that as the ink for preparing the coating liquid for forming a separation layer, 100 parts by mass of ink (Lamic F220 779 Grass, available from Dainichiseika Color & Chemicals Mfg.Co.,Ltd) containing a pigment (mainly chloro copper phthalocyanine) and a urethane resin was used.

### Comparative Example 8

A double-sided adhesive tape was prepared in the same manner as in Example 1-1 except that as the ink for preparing the coating liquid for forming a separation layer, 100 parts by mass of ink (Lamic F220 950 Red, available from Dainichiseika Color & Chemicals Mfg.Co.,Ltd.) containing a pigment (monoazo-based pigment) and a urethane resin was used.

### Comparative Example 9

A double-sided adhesive tape was prepared in the same manner as in Example 1-1 except that as the ink for preparing the coating liquid for forming a separation layer, 100 parts by mass of ink (Lamiall Mark III R Bright Red 365, available from SAKATA INX CORPORATION) containing a pigment (disazo-based pigment) and a urethane resin was used.

The obtained double-sided adhesive tape was evaluated for peeling characteristics, peel force (adhesive strength in a direction perpendicular to the adhesive surface), tensile shear force, tensile stress at break and tensile elongation at break of the separation layer, impact resistance, and re-adhesiveness, by the following methods.

### Peeling Characteristics

A stainless steel sheet (SUS304 BA) with a thickness of 53 mm×100 mm and a thickness of 1 mm and a glass plate with a thickness of 53 mm×100 mm and a thickness of 1.75 mm were prepared.

The prepared double-sided adhesive tape was cut into 4 mm×100 mm, and the surface on the second adhesive layer side was attached along the end side on a long side of the glass plate.

Next, the surface of the double-sided adhesive tape on the side of the first adhesive layer and the stainless steel sheet were attached so that the glass plate and the stainless steel sheet overlapped with each other.

After leaving it for 20 minutes or more, the stainless steel sheet and the glass plate were disassembled using a scraper (peeling spatula R40 mm, available from Inouekougu Co., Ltd.), and the peeling characteristics were evaluated. In a case where the double-sided adhesive tape is easily peeled off at the interface between the separation layer and the film substrate, it was evaluated as “A”, In a case where the double-sided adhesive tape is peeled off at the interface between the separation layer and the film substrate, it was evaluated as “B”, in a case where the double-sided adhesive tape is not easily peeled off at the interface between the separation layer and the film substrate, it was evaluated as “C”.

### Peel Force

Two stainless steel (SUS304) T-shaped blocks with an adhered surface of 25 mm×25 mm, a knob extending vertically from the adhered surface of 20 mm, and a thickness of each part of 5 mm were prepared, and a 15×15 mm double-sided adhesive tape was attached to the center of one T-shaped block.

The other T-shaped block was attached to the surface of the double-sided adhesive tape that was not attached to the T-shaped block so that the knobs of the block were crossed in a cross.

In an environment of 24° C., a 5 kg weight was placed on the knob for 1 minute, crimped, and then left for 72 hours to measure the maximum value of the peel force when the T-shaped blocks were peeled off from each other.

Further, when the first adhesive layer was Y-4825K, Y-4914, and 86425, the maximum values of the peel force were 112N/15×15 mm, 121N/15×15 mm, and 88N/15×15 mm, respectively.

### Tensile Shear Force

In an environment of 24° C., in accordance with JIS Z 1541 (2009), a double-sided adhesive tape having a thickness of 15 mm×15 mm was attached to a stainless steel sheet (SUS304 BA), and the maximum value of tensile shear force was measured at a tensile speed of 50 mm/min.

The maximum values of the tensile shear force when the first adhesive layer was Y-4825K, Y-4914, and 86425 were 210N/15×15 mm, 374N/15×15 mm, and 199N/15×15 mm, respectively.

### Tensile Stress and Tensile Elongation

A coating liquid for forming a separation layer was applied to a liner (75RL-07, available from Oji F-Tex Co.,Ltd.) with a comma coater, dried at 65° C. for 1 hour, dried at 65° C. for 1 hour, then cured (thermosetting) at 50° C. for 3 days to prepare a film having a separation layer with a thickness of 7 to 13 μm formed on the liner.

After cutting the produced film into strips with a width of 15 mm together with the liner, an adhesive cellulose tape (15 mm width, available from NICHIBAN CO., LTD.) was attached to the front and back of the film peeled off from the liner at intervals of 25 mm.

In a case where a tack remained on the separation layer and it was difficult to handle, talc was applied to the surface layer of the separation layer for work.

A tensile test was performed by grasping a part covered with cellulose tape using a tensile tester (tensilon universal testing machine RTG-1225, load cell UR250N D, available from Orientec Co., Ltd.), gripping width of 25 mm, tensile speed of 50 mm/min).

The tensile stress and tensile elongation at which the separation layer was broken were measured.

### Impact Resistance

The shape of the prepared double-sided adhesive tape on the outer frame side was in 29 mm×29 mm (the corners are curved at 3r), and a rectangular frame-shaped die having a shape of 19 mm×19 mm (curved at a corner of 2r) on the inner frame side was punched out from the first adhesive surface side, and a rectangular frame-shaped double-sided adhesive tape having a width of 5 mm was obtained.

Similarly, a rectangular frame-shaped double-sided adhesive tape having a width of 5 mm was further obtained.

The first adhesive layer of one rectangular frame-shaped double-sided adhesive tape and a stainless steel sheet (55 mm×55 mm, thickness 1 mm) with a 16<D hole in the center were attached to each other so that the center of the double-sided adhesive tape coincided with the center of the stainless steel sheet.

Next, the double-sided adhesive tape attached to the stainless steel sheet was peeled off at the interface between the separation layer and the film substrate using a scraper to remove a part on the second adhesive surface from the film substrate.

The second adhesive layer of the other rectangular frame-shaped double-sided adhesive tape and an acrylic plate (30 mm×30 mm, thickness 2 mm) were attached to each other.

Next, the double-sided adhesive tape attached to the acrylic plate was peeled off at the interface between the film substrate and the separation layer using a scraper to remove a part of the separation layer from the first adhesive material.

The peeling surface (separation layer) of the double-sided adhesive tape left after being attached to the stainless steel sheet and the rectangular peeling surface (film substrate) of the double-sided adhesive tape left after being attached to the acrylic plate are overlapped, and a 10 kg roller was pressure-bonded once in two directions along the frame of the rectangular frame-shaped double-sided adhesive tape.

A jig having a cylinder with an inner diameter of 24 mm and a length of 400 mm was placed on the surface of the stainless steel sheet opposite to the double-sided adhesive tape so that the center of the stainless steel sheet and the center of the cylinder of the jig coincided with each other.

A 50 g or 100 g conical weight was naturally dropped along the cylinder so that the weight would fall on an acrylic plate attached to the stainless steel sheet.

The weights of 50 g and 100 g were repeated 3 times each (6 times in total) and dropped onto the acrylic plate to check if the acrylic plate fell off from the stainless steel sheet.

Those in which the acrylic plate did not fall off were evaluated as “A”, and those in which the acrylic plate fell off were evaluated as “B”.

Table 1 shows the evaluation results of the examples and comparative examples. In addition, “-” in the table means that it has not been measured or cannot be measured.

TABLE 1

| | | | Tensile | | | |
|---|---|---|---|---|---|---|
| | | Peel | shear | | | |
| | | force | force | Tensile | Tensile | |
| | Peeling | (N/ 15 × | (N/ 15 × | stress | elongation | Impact |
| | characteristics | 15 mm) | 15 mm) | (Mpa) | (%) | resistance |
| Example 1-1 | B | 138 | 181 | 2.8 | 612 | A |
| Example 2-1 | B | 135 | 159 | 2.5 | 57 | A |
| Example 2-2 | B | 129 | 345 | | | |
| Example 2-3 | B | 97 | 274 | | | |
| Example 3-1 | B | 137 | 147 | 2.5 | 57 | A |
| Example 3-2 | B | 135 | 290 | | | |
| Example 3-3 | B | 92 | 253 | | | |
| Example 4-1 | B | 154 | 239 | 1.3 | 166 | A |
| Example 4-2 | B | 136 | 226 | | | |
| Example 5-1 | B | 137 | 182 | 1.3 | 166 | A |
| Example 5-2 | B | 136 | 302 | | | |
| Example 6-1 | B | 133 | 133 | 3.3 | 417 | A |
| Example 7-1 | B | 143 | 257 | 24.6 | 220 | B |
| Example 8-1 | B | 145 | 244 | 24.6 | 220 | B |
| Example 9-1 | A | 144 | 220 | 19.3 | 47 | B |
| Example 9-2 | B | 132 | 314 | | | |
| Example 9-3 | B | 112 | 297 | | | |
| Example 10-1 | B | 148 | 236 | 24.8 | 47 | B |
| Example 10-2 | B | 139 | 424 | | | |
| Example 10-3 | B | 116 | 314 | | | |
| Example 11-1 | B | 132 | 170 | 24.8 | 117 | B |
| Example 11-2 | B | 99 | 388 | | | |
| Example 11-3 | B | 122 | 164 | | | |
| Example 12-1 | A | 150 | 254 | 19.3 | 47 | B |
| Example 13-1 | A | 138 | 243 | 24.8 | 47 | B |
| Example 13-2 | B | 107 | 379 | | | |
| Example 13-3 | A | 101 | 221 | | | |
| Example 14-1 | A | 142 | 186 | 15.4 | 47 | B |
| Example 14-2 | B | 153 | 374 | | | |
| Example 14-3 | A | 136 | 267 | | | |
| Example 15-1 | B | 121 | 166 | 11.6 | 31 | B |
| Example 16-1 | B | 115 | 146 | 14.5 | 31 | B |
| Example 17-1 | B | 121 | 156 | 27.7 | 40 | B |
| Example 17-2 | B | 113 | 251 | | | |
| Comparative | C | — | — | 22.7 | 492 | — |
| Example 1 | | | | | | |
| Comparative | C | — | — | 19.3 | 138 | — |
| Example 2 | | | | | | |
| Comparative | C | — | — | 1.7 | 157 | — |
| Example 3 | | | | | | |
| Comparative | C | — | — | 12.8 | 54 | — |
| Example 4 | | | | | | |
| Comparative | C | — | — | 10 | 37 | — |
| Example 5 | | | | | | |
| Comparative | C | — | — | 5.3 | 6 | — |
| Example 6 | | | | | | |
| Comparative | C | — | — | 19.3 | 138 | — |
| Example 7 | | | | | | |
| Comparative | C | — | — | 12.8 | 54 | — |
| Example 8 | | | | | | |
| Comparative | C | — | — | 5.3 | 6 | — |
| Example 9 | | | | | | |

1. A double-sided adhesive tape comprising:
a first adhesive layer, wherein the first adhesive layer is foam;
a separation layer containing a pigment, the separation layer being provided on the first adhesive layer;
a film substrate directly laminated on the separation layer; and
a second adhesive layer provided on the film substrate,
wherein the pigment contains at least one selected from the group consisting of carbon black, titanium oxide, and phthalocyanine blue.

2. (canceled)

3. The double-sided adhesive tape according to claim 1, wherein a tensile stress at break of the separation layer is less than 4 MPa.

4. The double-sided adhesive tape according to claim 3, wherein the separation layer is a coating film of a coating liquid containing the pigment and a binder resin, the separation layer containing the pigment and the binder resin.

5. The double-sided adhesive tape according to claim 1, wherein a tensile stress at break of the separation layer is 4 MPa or greater, and a tensile elongation at break of the separation layer is 360% or less.

6. The double-sided adhesive tape according to claim 5, wherein the separation layer is a coating film of a coating liquid containing the pigment, a binder resin, and a curing agent, the separation layer containing the pigment and a cured product of the binder resin.

7. The double-sided adhesive tape according to claim 1, further comprising an auxiliary layer directly laminated on the first adhesive layer, wherein the separation layer is directly laminated on the auxiliary layer.

8. An article comprising:
a first component;
a second component; and
a bonding portion that bonds the first component and the second component, the bonding portion including a first region formed of the double-sided adhesive tape described in claim 3, and a second region formed of the double-sided adhesive tape described in claim 5.

9. A method of disassembling two or more components bonded by the double-sided adhesive tape described in claim 1, the method comprising inserting a flat instrument from a side surface of the double-sided adhesive tape and peeling off an interface between the separation layer and the film substrate.

10. The article of claim 8, wherein the separation layer is a coating film of a coating liquid containing the pigment and a binder resin, the separation layer containing the pigment and the binder resin; and wherein the separation layer is a coating film of a coating liquid containing the pigment, a binder resin, and a curing agent, the separation layer containing the pigment and a cured product of the binder resin.
